(19) United States
(12) Patent Application Publication
(10) Pub. No.: US 2015/0274129 A1
(43) Pub. Date: Oct. 1, 2015

(54) WINDSHIELD WIPER ASSEMBLY HAVING SPLINE LOCK COUPLER

(71) Applicant: TRICO PRODUCTS CORPORATION, Rochester Hills, MI (US)

(72) Inventor: John Foss, Troy, MI (US)

(73) Assignee: TRICO PRODUCTS CORPORATION, Rochester Hills, MI (US)

(21) Appl. No.: 14/242,116

(22) Filed: Apr. 1, 2014

(51) Int. Cl. B60S 1/38

(52) U.S. Cl. CPC B60S 1/381; B60S 2001/3827

(57) ABSTRACT

The present invention relates to wiper assembly that includes a wiping element adapted to contact a surface and having head portion and a wiping portion, a pair of supporting elongated splines each having at least one aperture, and a coupler with a base portion, a pair of side walls, at least one pair of claws facing each other that have an upper element extending laterally inwardly terminating to define a channel between the claws to receive the head portion of the wiping element, a lower element spaced below the upper element, and a retention gap defined therebetween with the splines at least partially disposed therein, and at least one pair of resilient locking tabs extending laterally inwardly from the side walls and being disposed in the apertures of the splines so as to independently retain the splines with respect to the coupler and independently space the splines laterally with respect to each other.

### BACKGROUND OF THE INVENTION

1. Field of the Invention

The present invention relates generally to wiper assemblies for wiper systems, and more specifically, to wiper assemblies having a spline lock coupler.

2. Description of the Related Art

Conventional automotive wiper systems known in the art include some type of wiper assembly (sometimes referred to as a wiper blade) mounted to a wiper arm which, in turn, is mounted adjacent to a surface to be wiped, such as a windshield of a vehicle, and pivotally driven to impart reciprocal motion to the wiper assembly across the windshield. The wiper assembly typically includes a rubber wiping element that contacts the windshield across the surface to be wiped. The wiper assembly often incorporates one or more metal strips that act to reinforce the wiping element and facilitate wiping contact by the wiping element across what is typically a curved glass surface. In this context, the wiper arm delivers a downward force to the wiper assembly that is distributed thereacross, pressing the wiper assembly into contact with the windshield. The wiper assembly may also include additional components such as an airfoil and a pair of end caps located at the distal ends of the wiper assembly. The wiper assembly may further include a coupler that connects the wiper assembly to the wiper arm.

Each of the components of a windshield wiper assembly of the type described above must cooperate to effectively clean a surface to be wiped. In addition, each of the components must be designed not only to facilitate an improved wipe quality, but also so as to ease the manufacture of the windshield wiper assembly. While the wiper systems known in the related are have generally performed well for their intended purpose, there remains a need in the art for a wiper system that has superior operational characteristics, while at the same time reduces the cost of manufacturing the assembly.

### SUMMARY OF THE INVENTION

The present invention overcomes the disadvantages in the related art in a windshield wiper assembly with a spline lock coupler. The wiper assembly includes a wiping element adapted to contact a surface to be wiped, which has a head portion and a wiping portion. The wiper assembly also includes a pair of elongated splines acting to support the wiping element, each of which has at least one aperture. The wiper assembly further includes a coupler with a base portion, a pair of side walls extending from the base portion, and at least one pair of claws formed on each of the side walls and facing each other. Each of the claws has an upper element that extends laterally inwardly and terminates to define a channel between the claws so as to receive the head portion of the wiping element. A lower element is spaced below the upper element and extends laterally inwardly. A retention gap is defined between the upper element and the lower element, and the splines are at least partially disposed therein. The coupler further includes and at least one pair of resilient locking tabs that extend laterally inwardly from each of the side walls to an end, where the locking tabs are disposed in the apertures of the splines so as to independently retain the splines with respect to the coupler and independently space the splines laterally with respect to each other.

In addition, the present invention is a wiper assembly that includes a wiping element adapted to contact a surface to be wiped and has a head portion and a wiping portion. The wiper assembly also includes a pair of elongated splines acting to support the wiping element, each of which has at least one aperture. The wiper assembly further includes an airfoil operatively attached to the elongated splines. The wiper assembly still further includes a pair of end caps operatively attached to each of the opposing longitudinal ends of the pair of splines. The wiper assembly further includes a coupler with a base portion, a pair of side walls extending from the base portion, and at least one pair of claws formed on each of the side walls and facing each other. Each of the claws has an upper element that extends laterally inwardly and terminates to define a channel between the claws so as to receive the head portion of the wiping element. A lower element is spaced below the upper element and extends laterally inwardly. A retention gap is defined between the upper element and the lower element, and the splines are at least partially disposed therein. The coupler further includes and at least one pair of resilient locking tabs that extend laterally inwardly from each of the side walls to an end, where the locking tabs are disposed in the apertures of the splines so as to independently retain the splines with respect to the coupler and independently space the splines laterally with respect to each other.

In this way, the coupler of the present invention attaches the coupler and support members of a wiper assembly together. The coupler of the present invention improves retention of the support members to the coupler and separates the splines of the support member to allow the free movement of the wiping element. Further, the coupler of the present invention provides advantages related to manufacturing and component assembly. The coupler of the present invention can be used for wiper systems in any type of transportation, such as automotive vehicles, heavy-duty trucks, trains, air planes, ships, large construction vehicles, military vehicles, or any other type of vehicles that contain surface wiper systems.

Other objects, features, and advantages of the present invention will be readily appreciated as the same becomes better understood after reading the subsequent description taken in connection with the accompanying drawings.

### BRIEF DESCRIPTION OF THE DRAWINGS

FIG. 1 is a partial perspective view of a front of a vehicle having a pair of wiper assemblies, according to one embodiment of the present invention, pivotally mounted for reciprocal movement across a windshield of the vehicle.

FIG. 2 is an enlarged perspective view of one of the wiper assemblies, according to one embodiment of the present invention, of FIG. 1.

FIG. 3 is an exploded perspective view of the wiper assembly, according to one embodiment of the present invention, of FIG. 2.

FIG. 4 is an enlarged perspective view of a coupler assembly and a portion of the wiper assembly, according to one embodiment of the present invention, of FIGS. 2 and 3.

FIG. 5 is an enlarged side view of the coupler assembly and a portion of the wiper assembly, according to one embodiment of the present invention, of FIGS. 2 and 3.

FIG. 6 is an enlarged top view of the coupler assembly and a portion of the wiper assembly, according to one embodiment of the present invention, of FIGS. 2 and 3.

FIG. 7 is an enlarged bottom view of the coupler assembly, according to one embodiment of the present invention, of FIGS. 2 & 3.

FIG. 8 is an enlarged bottom view of the coupler assembly and one support member, according to one embodiment of the present invention, of FIGS. 2 & 3.

FIG. 9 is an enlarged bottom view of the coupler assembly and two support members, according to one embodiment of the present invention, of FIGS. 2 & 3.

FIG. 10 is an enlarged bottom view of the coupler assembly, two support members, and a wiping element, according to one embodiment of the present invention, of FIGS. 2 & 3.

FIG. 11 is a sectional view taken along line 11-11 of FIG. 7.

FIG. 12 is a sectional view taken along line 12-12 of FIG. 7.

FIG. 13 is a sectional view taken along line 13-13 of FIG. 7.

FIG. 14 is an enlarged partial perspective view of the two support members of the wiper assembly of FIGS. 2 and 3.

FIG. 15 is a sectional view taken along line 15-15 of FIG. 10.

FIG. 16 is a sectional view taken along line 16-16 of FIG. 10.

### DETAILED DESCRIPTION OF THE EMBODIMENTS OF THE INVENTION

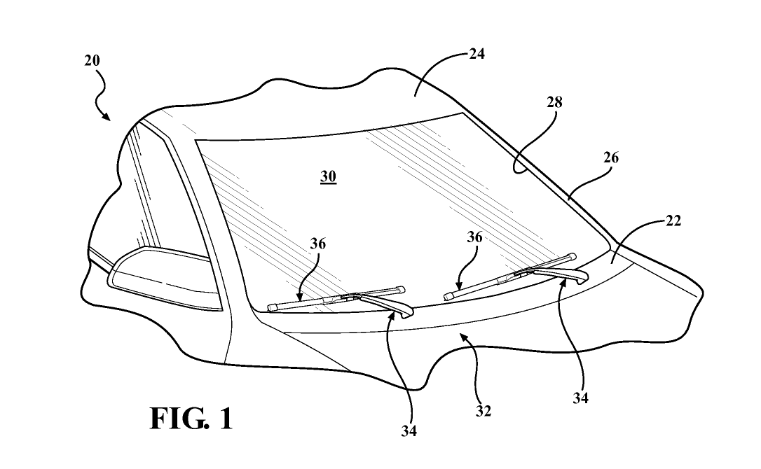

With reference to the Figures, where like numerals are used to designate like structure throughout the several views, a portion of a vehicle is schematically illustrated at 20 in FIG. 1. The vehicle 20 includes a cowl 22, a roof 24, and a pair of laterally spaced front “A” pillars 26 extending between the roof 24 and the cowl 22. The A-pillars 26, roof 24, and cowl 22 cooperate to define a generally rectangular opening 28 in which is supported a curved or “swept back” glass windshield 30. As illustrated, the vehicle 20 is an automobile, but may be any type of vehicle, such as heavy-duty trucks, trains, airplanes, ships, construction vehicles and equipment, military vehicles, or any other type of vehicle that contains surface wiper systems.

A wiper system is generally indicated at 32 in FIG. 1 and is employed to clean the windshield 30. The wiper system 32 includes a pair of wiper arms, generally indicated at 34, and a pair of wiper assemblies, generally indicated at 36, which correspond to the driver and passenger sides of the vehicle 20. However, those having ordinary skill in the art will appreciate that the wiper system 32 could employ a single wiper arm 34 and single wiper assembly 36, or more than two wiper arms 34 and more than two wiper assemblies 36 without departing from the scope of the present invention.

In the representative example illustrated herein, each wiper assembly 36 is carried by a corresponding wiper arm 34. The wiper arm 34 may include an attachment member (not shown, but generally known in the art) adapted to operatively engage the wiper assembly 36. The wiper system 32 also includes an electrical motor (not shown, but generally known in the art) to move the wiper assemblies 36 in an oscillating manner across the surface of the windshield 30.

While the wiper assembly 36 illustrated in FIG. 1 is shown in connection with the front windshield 30 of the vehicle 20, those having ordinary skill in the art will appreciate that wiper assemblies 36 may be employed in other areas of the vehicle 20 that employ a wiper system, such as a rear window (not shown) or a head lamp (not shown). Thus, it will be understood that the present invention is not limited for use solely in connection with wiper arms 34 adapted for use on a vehicle's windshield 30, but for use in all applications where wiper systems 32 are employed.

Referring to FIGS. 2 through 4, the wiper assembly 36 includes a wiping element 38 that is adapted to contact a surface of the vehicle 20 to be wiped, in this representative example, the windshield 30. The wiper assembly 36 also includes at least one support member 42 that defines a longitudinal axis and that acts to reinforce or support the wiping element 38. In the representative embodiment illustrated herein, the support member 42 is a pair of splines 42a that operatively reinforce or support the wiping element 38. However, those having ordinary skill in the art will appreciate from the description that follows that the support member 42 may be either monolithic or defined by a pair of splines 42a. The wiper assembly 36 may also include an airfoil assembly, generally indicated at 44, to prevent the wiper assembly 36 from lifting from the surface of the windshield 30. The wiper assembly 36 may further include one or more end caps, generally indicated at 46, to prevent the airfoil assembly 36 from disengaging the support member 42. Each of the above components will be described in greater detail below.

As illustrated in FIGS. 2, 3, and 10, the wiping element 38 includes an upper head portion 38a and a lower portion 38b that are partitioned by a longitudinally extending bridge or hinge portion 38c. The hinge portion 38c provides flexibility between the upper portion 38a and the lower portion 38b during operational movement of the wiper assembly 36 across the surface to be wiped. The upper portion 38a includes opposed grooves 39 extending laterally therein and longitudinally therealong between its longitudinal ends. The grooves 39 receive the splines 42a of the support member 42 and cooperate with the splines 42a as will be described in detail below. The wiping element 38 is configured to a predetermined length corresponding to particular application, and is often manufactured through an extrusion process which enables the length of the wiping element 38 to be easily adjusted without a substantial increase in manufacturing expense. Furthermore, while the wiping element 38 of the present invention is constructed from a flexible rubber, those having ordinary skill in the art will appreciate that it may be constructed from any flexible material, such as silicone or another polymer, without departing from the scope of the present invention.

The support member 42 may be constructed from a resiliently flexible material, such as spring steel or a polymer, and is adapted to apply force from an intermediate position between its longitudinal ends. More specifically, the support member 42 receives force from the spring loaded wiper arm 34 at an intermediate position and distributes this force across the span of the support member 42 toward its longitudinal ends. To that end, the support member 42 may be curved longitudinally with a predetermined radius of curvature. In the related art, this predetermined radius of curvature is sometimes referred to as a “free form” radius of curvature. Accordingly, the curvature of the support member 42 may be symmetrical or asymmetrical, depending on the force requirements of the application and the contour of the windshield 30. The flexible, free form, pre-curved support member 42 straightens out when the wiper arm 34 applies a force thereto to flatten the support member 42, and directs the wiping element 38 to contact the windshield 30. Thus, the elongated support member 42 includes a free-form curvature that ensures force distribution on windshields having various curvatures and that effects proper wrapping about the windshield 30.

As illustrated throughout the figures, the support member 42 may have a substantially constant width and a constant thickness throughout the length between its longitudinal ends. The constant width and thickness are adapted to provide high lateral and torsional stiffness to avoid lateral and torsional deflections, which cause the wiping element 38 to stick/slip (“chatter”) on the windshield 30 during operation. Thus, the cross-section of the support member 42 has a generally rectangular outer profile that makes the support member 42 easier to manufacture. More specifically, where the support member 42 is constructed from metal, such as spring steel, the tools and machinery used to manufacture the support member 42 are less complicated than that required to manufacture one having varying widths and/or thickness. Furthermore, where the support member 42 is constructed from a polymer, such as a thermoplastic elastomer, the tools and extrusion process machinery are also less complicated than those employed to manufacture varying widths and/or thicknesses. However, those having ordinary skill in the art will appreciate that the support member 42 illustrated herein may include a varying thickness and/or width without departing from the scope of the present invention. Further, those having ordinary skill in the art will appreciate that the support member 42 could be monolithic or a plurality of splines 42a.

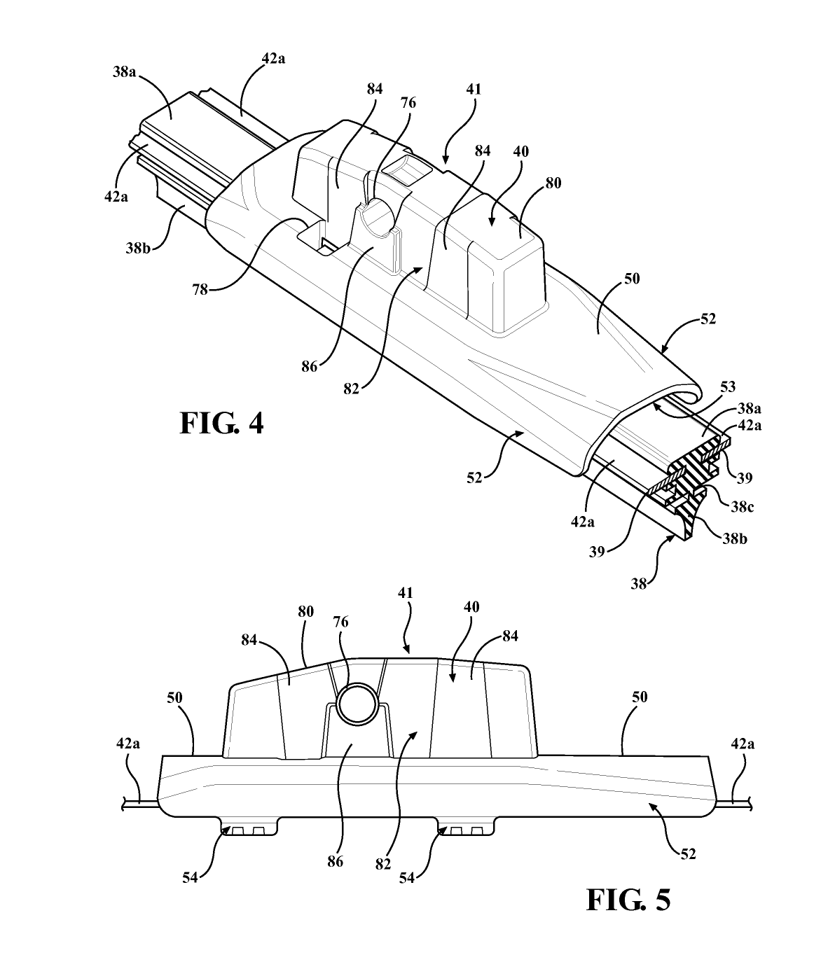

As illustrated in FIG. 4, the splines 42a of the support member 42 are disposed in the grooves 39 of the wiping element 38. The support member 42 may include one or more notches (not shown, but generally known in the art) located near the longitudinal ends of the splines 42a of the support member 42. Notches are generally trapezoidal or rectangular in shape, but may be any suitable shape. Notches cooperate with the end caps 46 to retain the end caps 46 to the support member 42 as will be described in greater detail below.

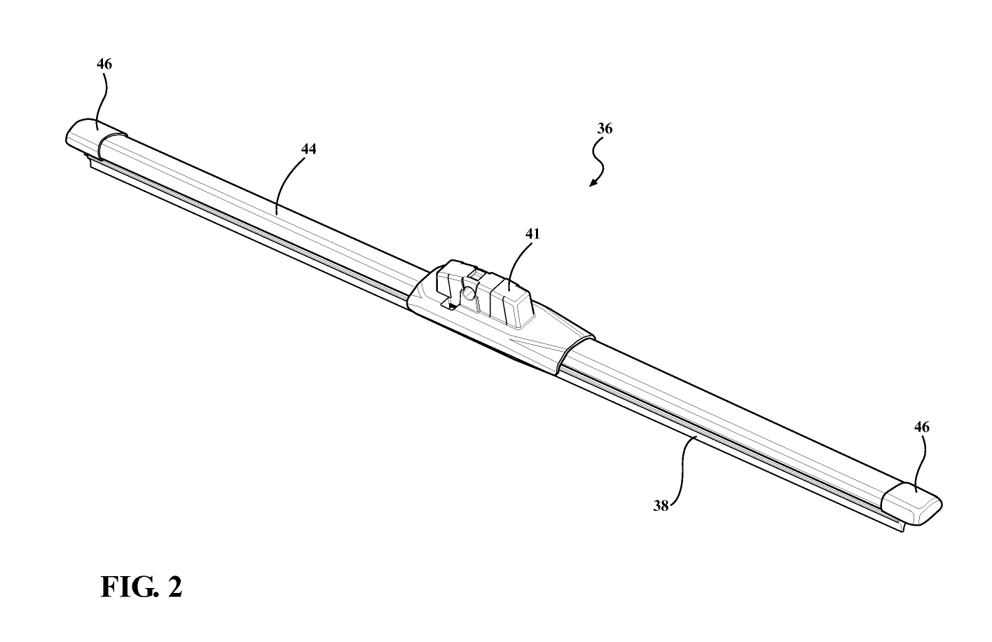

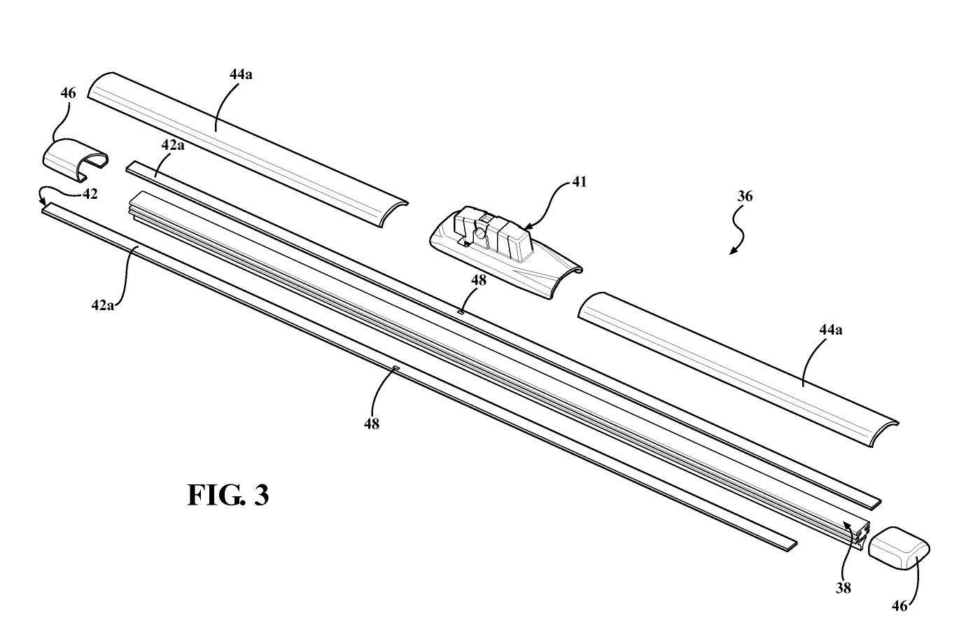

Additionally, the support member 42 may include one or more apertures 48 extending therein. In the embodiment illustrated in FIGS. 3 and 14, the apertures 48 are located near the longitudinal center of the support member 34. One aperture 48 is disposed in each spline 42a of the support member 42 such that the apertures 48 oppose each other. The apertures 48 are generally rectangular in shape, but may be any suitable shape. The apertures 48 cooperate with the coupler assembly 41 as will be described in detail below.

As previously noted, in one of the embodiments of the present invention, the wiper assembly 36 may include an airfoil assembly, generally indicated at 44, to prevent the wiper assembly 36 from lifting from the surface of the windshield 30. The airfoil assembly 44 is operatively mounted to the wiping element 38 and support member 42. The airfoil assembly 44 extends along the length of the wiping element 38 and the support member 42. The airfoil assembly 44 acts to reduce the likelihood of wind lift by allowing air to flow over the wiper assembly 36. More specifically, and in the embodiment illustrated herein, the airfoil assembly 44 includes a pair of airfoil components 44a that are operatively mounted to the wiping element 38 and the support member 42 with the coupler assembly 41 extending therebetween. However, those having ordinary skill in the art will appreciate that the airfoil assembly 44 may be defined by a single unitary component without departing from the scope of the present invention.

As illustrated in FIGS. 2 and 3, the wiper assembly 36 may include a pair of end caps, generally indicated at 46. The end caps 46 are adapted to be disposed adjacent to the distal ends of the airfoil components 44a. The end caps 46 are secured to the support member 42. The end caps 46 include a profile that substantially mimics the contours of the airfoil assembly 44, to maintain the wind lift characteristics of the wiper assembly 36 and to provide an increased aesthetic value. The end caps 46 also provide a mass increase adjacent the distal ends of the airfoil components 44a that help prevent localized chatter along the extremities of the wiping element 38 caused by the combination of wind lift and a decrease in the force distributed to this area from the wiper arm 34 via the splines 42a, as described above. It should be appreciated that the end caps 46 may include a locking arm (not shown, but generally known in the art) or other features that engage notches (not shown) in the splines 42a of the support member 42.

As noted above, the wiper assembly 36 also includes a coupler, according to one embodiment of the present invention and generally indicated at 41. The coupler assembly 41 is adapted to connect the wiper assembly 36 to the wiper arm 34 via various types of adaptors/attachment members (not shown, but generally known in the art). More specifically, those having ordinary skill in the art will appreciate that different OEM's employ wiper arms 34 configured to releasably attach to different adaptors/attachment members which are, in turn, operatively attached to a specific wiper assembly. By way of example, certain wiper arms employed by OEM's include “bayonet-style”; “pin-type”; “hook-type”; “push-button”; “pinch-tab”; or “side-pin” attachment members of various sizes that are operatively attached to the wiper assemblies.

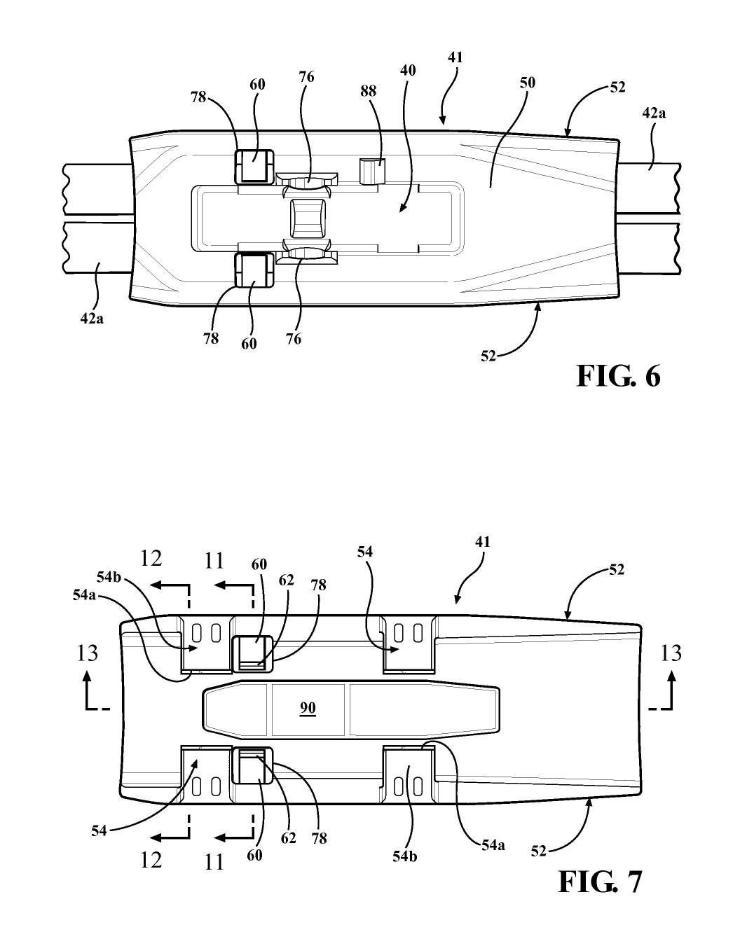

Accordingly, the coupler assembly 41 illustrated herein includes structure that operatively engages a plurality of adaptors/attachment members configured to releasably attach to one or more of these wiper arms 34. Specifically, as illustrated in FIGS. 4-6, the coupler assembly 41 includes a base portion 50 and a saddle 40 that extends therefrom. The saddle 40 is generally rectangular, but those having ordinary skill in the art will appreciate that it could be configured to be any shape suitable to attach to an adaptor/attachment member, or connect directly to the wiper arm 34. The saddle 40 includes a slightly arcuate top surface 80 and opposing longitudinal sides 82 extending therefrom. In the embodiments illustrated herein, the saddle 40 includes an elongated hollow section 90 in the underside thereof that is implemented for material savings. However, those having ordinary skill in the art will appreciate that the hollow section 90 could be configured to any suitable shape, or not be utilized at all, without departing from the scope of the present invention.

The saddle 40 further includes opposing cylindrical recesses 76 disposed in the opposing longitudinal sides 82 configured to engage an adapter (not shown, but generally known in the art). A pair of raised supports 86 are disposed below each of the opposing cylindrical recesses 76 and provide support to the adaptor/attachment member (not shown). Further, a pair of friction pads 84 are disposed on the opposing sides of the coupler assembly 41 and are configured to provide a slight interference between the coupler assembly 41 and the adaptor/attachment member to dampen rotation therebetween, which helps eliminate chatter of the wiping element 38 on the windshield 30 during operation. Those having ordinary skill in the art will appreciate that the connection system between the coupler assembly 41 and the adaptor/attachment member (not shown) could utilize any combination of trunnion, friction pads, pin or pins, cylindrical recesses, raised supports, and/or a through-hole without departing from the scope of the present invention. Further still, the coupler assembly 41 may include an adaptor brace 88 disposed on one or more sides of the saddle 40. The adaptor brace 88 cooperates with the adaptor/attachment member to properly align the wiper assembly 36 with the wiper arm 34 in specific applications.

Referring to FIG. 4, the coupler assembly 41 includes a pair of side walls 52 extending from the base portion 50 which define an opening, generally indicated at 53, which may receive a portion of each of the airfoil components 44a. It should be appreciated that the opening 53 could be configured to any shape that is substantially similar to the shape of the airfoil 44, or any suitable shape regardless of the use or shape of an airfoil 44 without departing from the scope of the present invention.

As shown in FIGS. 7 and 11-13, the coupler assembly 41 further includes at least one pair of claws 54 formed on each of the side walls 52 and facing each other. Each of the claws 54 includes an upper element 54a extending laterally inwardly and terminating to define a channel 56 between opposing claws 54. The channel 56 is adapted to receive or accommodate the head portion 38a of the wiping element 38. Each of the claws 54 further includes a lower element 54b spaced below the upper element 54a, which also extends laterally inwardly, and a retention gap 58 is defined between the upper element 54a and lower element 54b (see FIGS. 12 and 13). The retention gap 58 is configured to be substantially similar in shape to the splines 42a, which are at least partially disposed therein. The coupler assembly 41 further includes at least one pair of resilient locking tabs 60 extending laterally inwardly from each of the side walls 52 to an end 61. The locking tabs 60 are disposed in the apertures 48 of the splines 42a so to independently retain the splines 42a with respect to the coupler assembly 41 and independently space the splines 42a laterally with respect to each other. Each of the above components will be described in greater detail below.

As is illustrated throughout the figures, the width of the locking tabs 60 is configured to be substantially equal to the width of the apertures 48 of the splines 42a. However, those having ordinary skill in the art will appreciate that the width of the locking tabs 60 could be smaller than the width of the apertures 48 without departing from the scope of the present invention.

Further, in one embodiment, the coupler assembly 41 may include two pairs of claws 54, with each of the locking tabs 60 being disposed on the coupler assembly 41 longitudinally between the two pairs of claws 54. However, those having ordinary skill in the art will appreciate that any number of pairs of claws, and/or claws having different or varying geometry, may be used without departing from the scope of the present invention.

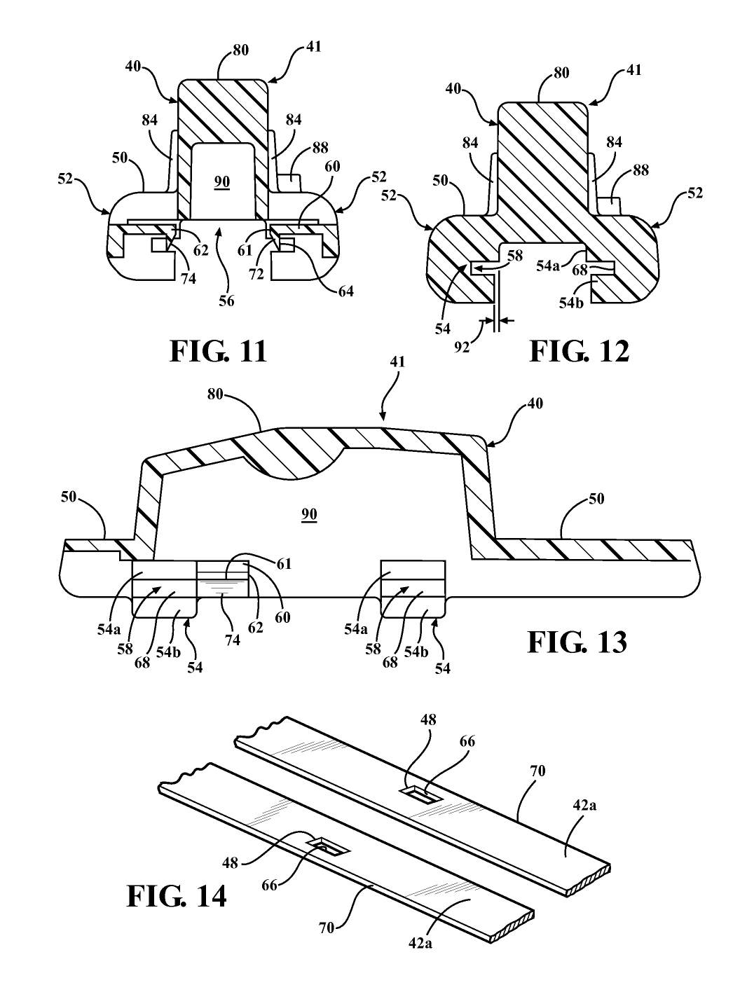

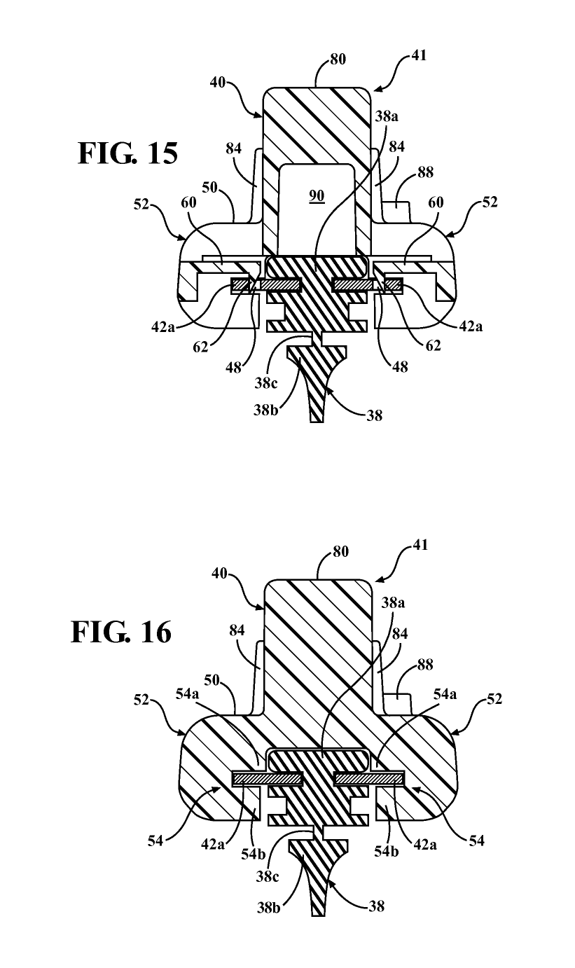

As best shown in FIGS. 11-14 and 15-16, in one embodiment, the locking tabs 60 each further include a hook section 62 disposed along the end 61 of the locking tab 60, which defines a retention surface 64 along the underside of the hook section 62. Moreover, the hook sections 62 further include an angled portion 72 defining an attack surface 74 for enabling cantilevered displacement of the locking tab 60 during spline 42a installation into the coupler assembly 41. The apertures 48 of the splines 42a each further define an interface surface 66 disposed along the inside of the apertures 48, wherein the retention surface 64 abuts the interface surface 66 once the splines 42a are installed into the coupler assembly 41, so as to retain the splines 42a with respect to the coupler assembly 41 and space the splines 42a laterally with respect to each other.

As is best shown in FIG. 12, the retention gaps 58 of the claws 54 each further include a terminal surface 68 defined between the upper element 54a and lower element 54b. Further, as is best shown in FIG. 14, the splines 42a include an outer edge 70 that abuts the terminal surface 68 of the retention gaps 58, so as to retain the splines 42a with respect to the coupler assembly 41. Specifically, the lateral distance between the outer edge 70 of the splines 42a and the interface surface 66 of the apertures 48 of the splines 42a is configured to be substantially equal to the lateral distance between the retention surface 64 of the hook sections 62 of the locking tabs 60 and the terminal surface 68 of the retention gaps 58 of the claws 54.

In one embodiment illustrated herein, as shown in FIG. 12, the lower element 54b of the claws 54, which extends laterally inwardly, terminates laterally before the upper element 54a and defines a lateral space 92 therebetween. This lateral gap 92 acts to ease spline 42a installation into the coupler assembly 41. However, those having ordinary skill in the art will appreciate that the extension of the lower element 54b could terminate at the same inward lateral distance as the upper element 54a, or could terminate laterally after the extension of the upper element 54a, without departing from the scope of the present invention.

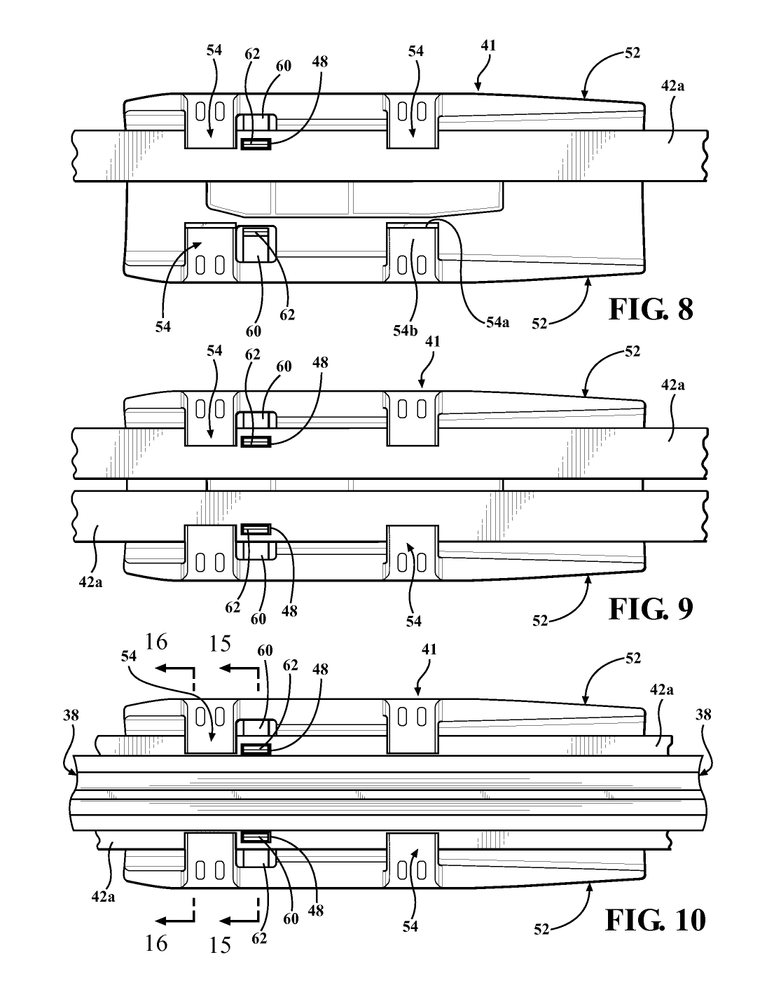

Referring now to FIGS. 7-10, in operation, the wiper assembly 36 is assembled by individually positioning the splines 42a of the support member 42 with the underside of the coupler assembly 41, such that the apertures 48 of the splines 42a are longitudinally aligned with the locking tabs 60 of the coupler assembly 42a. The splines 42a may be rested against the upper element 54a of the claws 54 in a parallel fashion or at a slightly oblique angle where, in one embodiment of the present invention, the lower element 54b terminates before the upper element 54a. As the spline is inserted into the retention gap 58 of the claws 54, the outer edge 70 of the splines 42a engages the attack surface 74 of the angled portion 72 of the hook section 62 disposed at the end 61 of the locking tab 60. As mentioned previously, the locking tab 60 is displaced upwardly into the coupler assembly 41 as the spline engages the attack surface 74 as it is inserted laterally into the retention gap 58 of the claws 54. Once the spline 42a is inserted fully into the retention gap 58 of the claws 54, such that the outer edge 70 of the spline 42a abuts the terminal surface 68 of the retention gap 58, the locking tab 60 returns and the retention surface 64 of the hook section 62 of the locking tab 60 engages the interface surface 66 of the apertures 48 of the splines 42a.

As illustrated throughout the views, an accommodation aperture 78 may be disposed in the base portion 50 of the coupler assembly 41, positioned above a portion of the locking tab 60, to enable upward cantilevered displacement of the locking tab 60 therein. However, those having ordinary skill in the art will appreciate that the coupler assembly 41 could be designed in such a way so as to omit the accommodation aperture 78 without departing from the scope of the present invention.

As illustrated in FIGS. 7-10, the splines 42a of the support member 42 can be independently installed into the coupler assembly 41 and the wiping element 38 can be installed therebetween by aligning the grooves 39 of the wiping element 38 with the splines 42a of the support element 42 and then longitudinally aligning the wiping element 38 with the support element 42. However, those having ordinary skill in the art will appreciate that the splines 42a could be installed into the coupler assembly 41 simultaneously, with or without the wiping element 38, without departing from the scope of the present invention.

As has been described, the coupler assembly 41 of the present invention attaches the splines 42a of a wiper assembly 36 thereto. The coupler assembly 41 improves retention of the splines 42a to the coupler 41 and separates the splines 42a to allow the free movement of the wiping element 38. Further, the coupler assembly 41 provides advantages related to manufacturing and component assembly. The coupler assembly 41 can be used for wiper systems in any type of transportation, such as automotive vehicles, heavy-duty trucks, trains, air planes, ships, large construction vehicles, military vehicles, or any other type of vehicles that contain surface wiper systems.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

What is claimed is:

1. A wiper assembly comprising:
a wiping element adapted to contact a surface to be wiped, said wiping element having a head portion and a wiping portion;
a pair of elongated splines acting to support said wiping element, each of said splines having at least one aperture; and
a coupler having a base portion, a pair of side walls extending from said base portion, at least one pair of claws formed on each of said side walls and facing each other; each of said claws having an upper element extending laterally inwardly and terminating to define a channel between said claws to receive said head portion of said wiping element; a lower element spaced below said upper element and extending laterally inwardly; a retention gap defined between said upper element and said lower element with said splines at least partially disposed therein, and at least one pair of resilient locking tabs extending laterally inwardly from each of said side walls to an end, said locking tabs being disposed in said apertures of said splines to independently retain said splines with respect to said coupler and independently space said splines laterally with respect to each other.

2. The wiper assembly as set forth in claim 1, wherein said locking tabs each further include a hook section disposed along said end and defining a retention surface, said apertures of said splines each defining an interface surface, said retention surface abutting said interface surface so as to retain said splines with respect to said coupler and space said splines laterally with respect to each other.

3. The wiper assembly as set forth in claim 2, wherein said retention gaps of said claws each further include a terminal surface, said splines include an outer edge, with said outer edge abutting said terminal surface so as to retain said splines with respect to said coupler.

4. The wiper assembly as set forth in claim 3, wherein the lateral distance between said outer edge and said interface surface is substantially equal to the lateral distance between said retention surface and said terminal surface.

5. The wiper assembly as set forth in claim 1, wherein the width of said locking tabs is substantially equal to the width of said apertures.

6. The wiper assembly as set forth in claim 2, wherein said hook sections further include an angled portion defining an attack surface for enabling cantilevered displacement of said locking tab during spline installation into said coupler.

7. The wiper assembly as set forth in claim 1, wherein said at least one pair of claws includes two pairs of claws, with each of said resilient locking tabs being disposed between said two pairs of claws.

8. The wiper assembly as set forth in claim 1, wherein said aperture is generally rectangular.

9. The wiper assembly as set forth in claim 1, wherein said upper element of said claws extends further laterally inwardly than said lower element of said claws

10. A wiper assembly comprising:
a wiping element adapted to contact a surface to be wiped, said wiping element having a head portion and a wiping portion;
a pair of elongated splines acting to support said wiping element, each of said splines having at least one aperture and opposing longitudinal ends;
an airfoil operatively attached to said elongated splines;
a pair of end caps operatively attached to each of said opposing longitudinal ends of said pair of splines; and
a coupler having a base portion, a pair of side walls extending from said base portion, at least one pair of claws formed on each of said side walls and facing each other; each of said claws having an upper element extending laterally inwardly and terminating to define a channel between said claws to receive said head portion of said wiping element; a lower element spaced below said upper element and extending laterally inwardly and terminating laterally before said upper element; and a retention gap defined between said upper element and said lower element with said splines at least partially disposed therein, and at least one pair of resilient locking tabs extending laterally inwardly from each of said side walls to an end, said locking tabs being disposed in said apertures of said splines to independently retain said splines with respect to said coupler and independently space said splines laterally with respect to each other.

11. The wiper assembly as set forth in claim 10, wherein said locking tabs each further include a hook section disposed along said end and defining a retention surface, said apertures of said splines each defining an interface surface, said retention surface abutting said interface surface so as to retain said splines with respect to said coupler and space said splines laterally with respect to each other.

12. The wiper assembly as set forth in claim 11, wherein said retention gaps of said claws each further include a terminal surface, said splines include an outer edge, with said outer edge abutting said terminal surface so as to retain said splines with respect to said coupler.

13. The wiper assembly as set forth in claim 12, wherein the lateral distance between said outer edge and said interface surface is substantially equal to the lateral distance between said retention surface and said terminal surface.

14. The wiper assembly as set forth in claim 10, wherein the width of said locking tabs is substantially equal to the width of said apertures.

15. The wiper assembly as set forth in claim 11, wherein said hook sections further include an angled portion defining an attack surface for enabling cantilevered displacement of said locking tab during spline installation into said coupler.

16. The wiper assembly as set forth in claim 10, wherein said at least one pair of claws includes two pairs of claws, with each of said resilient locking tabs being disposed between said two pairs of claws.

17. The wiper assembly as set forth in claim 10, wherein said aperture is generally rectangular.

18. The wiper assembly as set forth in claim 10, wherein said upper element of said claws extends further laterally inwardly than said lower element of said claws.
